(19) United States
(12) Patent Application Publication
(10) Pub. No.: US 2025/0308166 A1
(43) Pub. Date: Oct. 2, 2025

(54) IMPROVED QUALITY OF ANIMATION FOR COMPRESSED GEOMETRY

(71) Applicant: Advanced Micro Devices, Inc., Santa Clara, CA (US)

(72) Inventor: Holger Heinrich Gruen, Peissenberg (DE)

(21) Appl. No.: 18/619,585

(22) Filed: Mar. 28, 2024

(51) Int. Cl. G06T 17/20

(52) U.S. Cl. CPC G06T 17/205; G06T 2210/36

(57) ABSTRACT

An apparatus and method for performing efficient video processing that preserves clarity of complex surface details. In various implementations, a computing system includes a processing circuit and a display device. The processing circuit executes instructions of a video processing application that uses three-dimensional (3D) animation of objects. The circuitry generates a first low level of detail (LOD) object based on a high LOD object. The circuitry generates a curved surface patch for each of the multiple base triangles of the first low LOD object. The circuitry divides the base triangles into multiple sub-triangles and generates modified displacements at the vertices of the base triangles and the sub-triangles. The circuitry generates, using the modified displacements, another low LOD object that is a representation of the high LOD object and conveys it to the display device.

### BACKGROUND

### Description of the Relevant Art

Video processing methods are complex and include many different functions. Computing systems use advanced processors to satisfy the high computation demands. The video processing complexity increases as the resolution of display devices increases and the refresh rate of display devices increases. Additionally, high-definition video encoding applications are growing rapidly in the consumer market space. Further, video processing becomes more complex as the available data bandwidth decreases and the processing occurs in real-time. Further, video processing products can include streaming services, which are services that provide real-time presentation of content on a user's remote computing device where the content is updated in real-time based on user input. The content stored on remote servers is accessed through a network by the user's computing device such as a laptop computer, desktop computer, or other.

In addition to video game (or gaming) products, real-time video processing occurs for displaying three-dimensional (3D) objects in a variety of video processing products for other fields such as biomedicine, urban planning, education, marketing, architecture, filmmaking, engineering, and so forth. These video processing products can offer complex surface details of 3D models of objects. Additionally, these video processing products provide 3D animation of characters and objects. Depending on the application and its use, these 3D objects can be an avatar or a character of a video game or an educational presentation or a marketing presentation. These 3D objects can also be a human organ or a group of organs of a medical instructional presentation, a vehicle or moving components of vehicle subsystems in an engineering design simulation, and so on.

For a more appealing experience and better conveyance of information, users of the video processing application desire high visual fidelity. In order to provide such an experience, objects with a high level of detail (LOD) can be used. However, using the high LOD objects places significant demand on the memory and processing systems. To reduce these demands, low LOD objects are used to represent the high LOD objects. As used herein, the terms “low” and “high” are merely intended to indicate one object has lower or higher detail than the other. In other words, these terms are intended to indicate relative levels of detail. The level of detail used for each of the low LOD object and the high LOD object can vary. Typically, for three-dimensional (3D) animation, video processing applications use the low LOD object, rather than the high LOD object. A tradeoff is that the fidelity is reduced. Consequently, systems and methods for using low LOD objects with improved visual appearance are desired.

In view of the above, efficient methods and apparatuses for performing efficient video processing that preserves clarity of complex surface details are desired.

### BRIEF DESCRIPTION OF THE DRAWINGS

FIG. 1 is a generalized diagram of a computing system that performs efficient video processing that preserves clarity of complex surface details.

FIG. 2 is a generalized diagram of three-dimensional object representations used for performing efficient video processing that preserves clarity of complex surface details.

FIG. 3 is a generalized diagram of geometric shapes of an object used for performing efficient video processing that preserves clarity of complex surface details.

FIG. 4 is a generalized diagram of geometric shapes of an object used for performing efficient video processing that preserves clarity of complex surface details.

FIG. 5 is a generalized diagram of geometric shapes of an object used for performing efficient video processing that preserves clarity of complex surface details.

FIG. 6 is a generalized diagram of geometric shapes of an object used for performing efficient video processing that preserves clarity of complex surface details.

FIG. 7 is a generalized diagram of three-dimensional object representations used for performing efficient video processing that preserves clarity of complex surface details.

FIG. 8 is a generalized diagram of three-dimensional object surface representations used for performing efficient video processing that preserves clarity of complex surface details.

FIG. 9 is a generalized diagram of three-dimensional object representations used for performing efficient video processing that preserves clarity of complex surface details.

FIG. 10 is a generalized diagram of a method for performing efficient video processing that preserves clarity of complex surface details.

FIG. 11 is a generalized diagram of a method for performing efficient video processing that preserves clarity of complex surface details.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for performing efficient video processing that preserve the detail of complex surface details are contemplated. In various implementations, a computing system includes a computing device with a processing circuit connected to a display device. The circuitry of the processing circuit executes instructions of a video processing application that uses three-dimensional (3D) animation of objects to be presented to the user on the display device. To improve the visual quality of objects while using low LOD objects to represent high LOD objects, methods and systems are disclosed that generate a second (or modified) low LOD object that corresponds to a high LOD object.

To generate the second low LOD object, the processing circuit modifies a surface of the original (first) low LOD object to better reflect the surface detail of the high LOD object. As disclosed, the first low LOD object is represented by M geometric shapes, such as M base triangles, that provide a geometric representation of the first low LOD object. The processing circuit further divides each of the M triangles into multiple sub-triangles and generates surface points that are located on a curved surface above a corresponding base triangle. The surface points are located where vector normal (i.e., normal vectors) originating at the vertices of the sub-triangles intersect the curved surface. The curved surface enables a better approximation of the surface of a region of the high LOD object as will be described below. Generally speaking, the curved surface enables generation of a surface with undulations in both positive and negative directions as will be discussed. To generate the curved surface, in some implementations, the processing circuit uses at least coordinates of the sub-triangles and the formula or function corresponding to a curved height field for the corresponding base triangle. In an implementation, the curved height field is a triangular Bézier surface. However, other approaches are possible and are contemplated.

Each of the multiple surface points (e.g., thousands of surface points) on the curved surface is located a distance (or height), also referred to as the “displacement,” from a corresponding sub-triangle along a vertex normal perpendicular to the corresponding sub-triangle. In other words, the surface of the object at that point is displaced. Unlike the first low LOD object, the curved surface has one or more surface points with a displacement that is less than a corresponding displacement of the high LOD object for that given surface area. To generate surface points for the second low LOD object, a difference is found for a vertex normal between a surface point of the high LOD object and a surface point of the curved surface. This difference is used to modify the surface of the second low LOD. In this manner, the second low LOD object has improved surface detail compared to the first low LOD object while still retaining computational benefits of using low LOD objects. Further details of these techniques for performing efficient video processing that preserves clarity of complex surface details are provided in the following description.

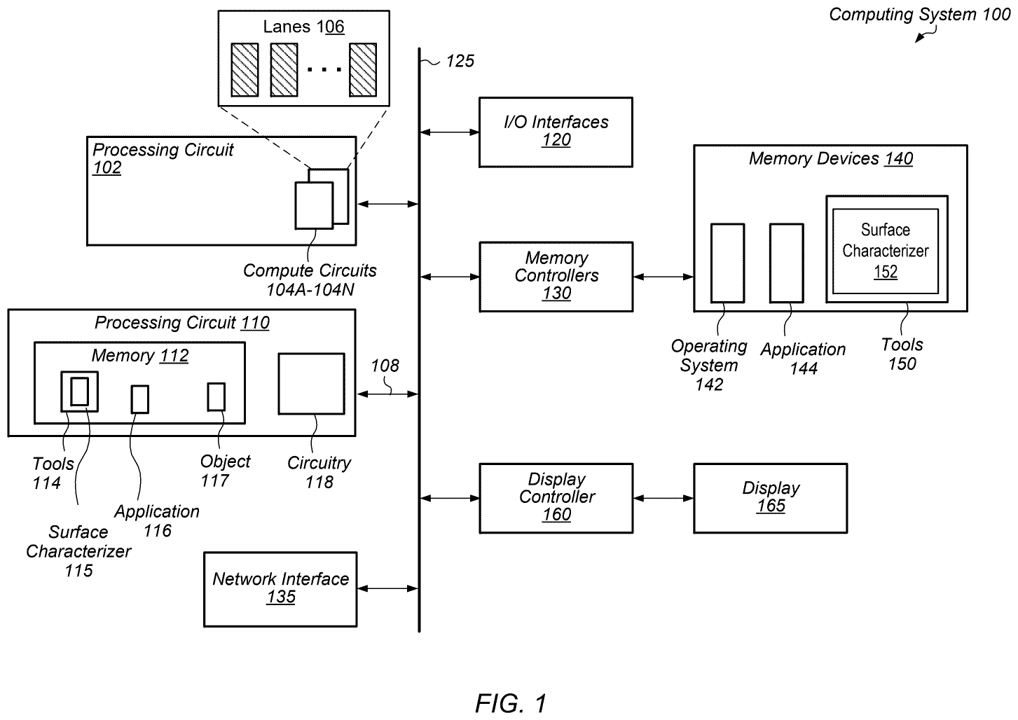

Turning now to FIG. 1, a generalized diagram is shown of an implementation of a computing system 100 that performs efficient video processing that preserves clarity of complex surface details. In an implementation, computing system 100 includes at least processing circuits 102 and 110, input/output (I/O) interfaces 120, bus 125, network interface 135, memory controllers 130, memory devices 140, display controller 160, and display 165. Processing circuits 102 and 110 are representative of any number of processing circuits which are included in computing system 100. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on the same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

In one implementation, processing circuit 102 is a parallel data processing circuit with a highly parallel data microarchitecture, such as a graphics processing unit (GPU). The processing circuit 102 can be a discrete device, such as a dedicated GPU (dGPU), or the processing circuit 102 can be integrated (an iGPU) in the same package as another processing circuit. In an implementation, the other processing circuit is processing circuit 110, which can be a central processing unit (CPU). Other parallel data processing circuits that can be included in computing system 100 include digital signal processing circuits (DSPs), field programmable gate arrays (FPGAs), application specific integrated circuits (ASICs), and so forth.

In various implementations, processing circuit 102 includes multiple compute circuits 104A-104N, each including similar circuitry and components such as the multiple, parallel computational lanes 106. In some implementations, the parallel computational lanes 106 (or lanes 106) operate in lockstep. In various implementations, the data flow within each of the lanes 106 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across lanes 106 includes the same circuitry and functionality, and operates on a same instruction, but different data associated with a different thread. A particular combination of the same instruction and a particular data item of multiple data items is referred to as a “work item.” A work item is also referred to as a thread.

The multiple work items (or multiple threads) are grouped into thread groups, where a “thread group” is a partition of work executed in an atomic manner. In some implementations, a thread group includes instructions of a function call that operate on multiple data items concurrently. Each data item is processed independently of other data items, but the same sequence of operations of the subroutine is used. As used herein, a “thread group” is also referred to as a “work block” or a “wavefront.” Tasks performed by the parallel data processing circuit 102 can be grouped into a “workgroup” that includes multiple thread groups (or multiple wavefronts). The hardware, such as circuitry, of a scheduler divides the workgroup into separate thread groups (or separate wavefronts), and assigns the thread groups to the compute circuits 104A-104N. In an implementation, a workgroup includes 8 wavefronts, one for each of eight compute circuits 104A-104N, and a wavefront includes 64 threads, one for each lane of the 64 lanes of the multiple lanes 106 of the compute circuits 104A-104N. In other implementations, another number of threads and wavefronts are used based on the hardware configuration of the parallel data processing circuit 102.

Although a single instruction multiple data (SIMD) micro-architecture can be used by compute circuits 104A-104N, other types of highly parallel data micro-architectures are possible and contemplated. The high parallelism offered by the hardware of the compute circuits 104A-104N is used for real-time data processing. Examples of real-time data processing are rendering multiple pixels, image blending, pixel shading, vertex shading, generating low level of detail (LOD) objects used in 3D animation, and geometry shading. In some cases, each of the data items of a wave front is a pixel of an image. The compute circuits 104A-104N can also be used to execute other threads that require operating simultaneously with a relatively high number of different data elements (or data items).

In one implementation, processing circuit 110 is a general-purpose processing circuit, such as a central processing unit (CPU), with any number of processing circuit cores that include circuitry for executing program instructions. Memory 112 represents a local hierarchical cache memory subsystem. Memory 112 stores source data, intermediate results data, results data, and copies of data and instructions stored in memory devices 140. For example, memory 112 stores the software tools 114 (or tools 114) and the application 116, which are copies of the tools 150 and the application 144 stored in the memory devices 140. Processing circuit 110 is coupled to bus 125 via interface 108. Processing circuit 110 receives, via interface 108, copies of various data and instructions, such as shader programs, the operating system 142, one or more device drivers, one or more applications such as application 144, a copy of the instructions of tools 150, and/or other data and instructions.

The processing circuit 110 retrieves a copy of the tools 150 from the memory devices 140, and the processing circuit 110 stores this copy as tools 114 in memory 112. In some implementations, tools 150 (and corresponding tools 114) provide one of a variety of types of software development kits (SDKs) that include graphic libraries of reusable functions (kernels) used to interface to a particular programming language with the use of application program interfaces (APIs). Tools 150 (and corresponding tools 114) can also include device drivers, hardware-specific tools that communicate with a particular embedded system, and other types of software for supporting application 144 (and corresponding application 116), which can be a video processing application. In various implementations, tools 150 includes surface characterizer 152.

The processing circuit 110 retrieves a copy of the application 144 from the memory devices 140, and the processing circuit 110 stores this copy as application 116 in memory 112. The processing circuit 110 also retrieves a copy of the tools 150 from the memory devices 140, and the processing circuit 110 stores this copy as tools 114 in memory 112. The surface characterizer 115 is a copy of the surface characterizer 152. One example of application 116 is a highly parallel data application that utilizes 3D animation. As part of compiling application 116, circuitry 118 translates instructions of application 116 into commands executable by the compute circuits 104A-104N of the processing circuit 102.

For example, when the instructions of the compiler are executed by the circuitry 118, the circuitry 118 uses a graphics library of tools 114 with its own application program interface (API) to translate function calls of the application 116 into commands particular to the compute circuits 104A-104N of the processing circuit 102. When executing instructions of one or more of tools 114, such as surface characterizer 115, and application 116, the circuitry of processing circuit 102 generates a first low level of detail (LOD) object based on a high LOD object. In various implementations, processing circuit 102 executes instructions of a video compression method to generate the first low LOD object. At this time, each of the low LOD object and the high LOD object is stationary. When executing commands of surface characterizer 115, circuit 102 is performing pre-processing steps prior to dynamically adjusting displacements when animation occurs during execution of application 116.

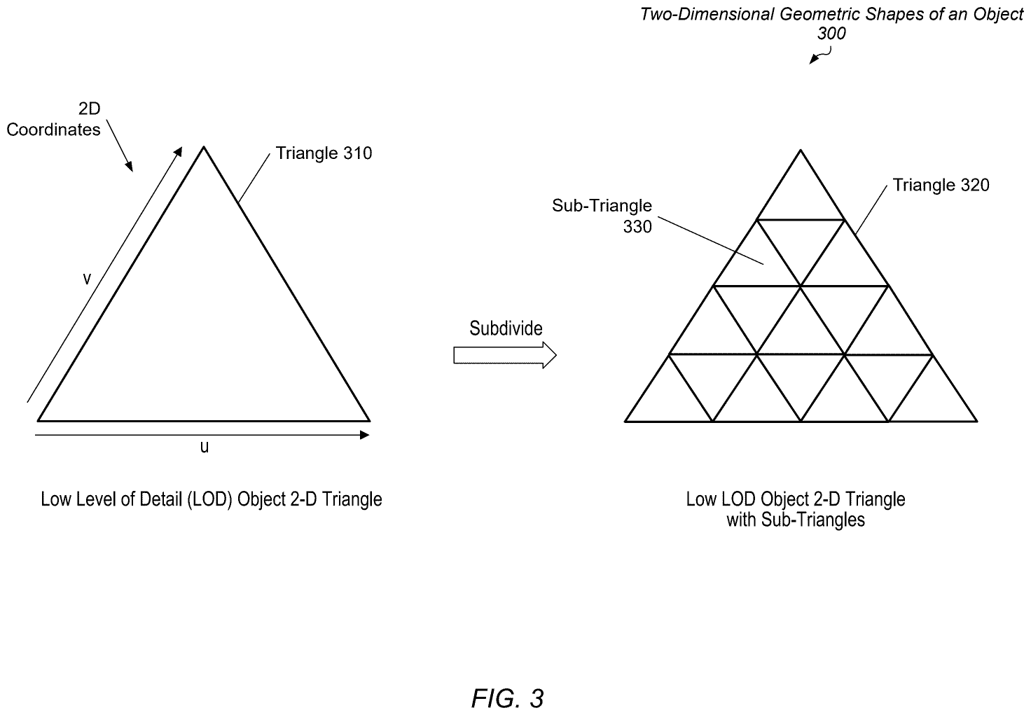

In some implementations, each of the high LOD object and the first low LOD object is a video game character for a video game application that uses 3D animation. In other implementations, depending on application 116 and its use, each of the high LOD object and the first low LOD object can be an avatar or a character of an educational or a marketing presentation, a human organ, or a group of organs of a medical instructional presentation, a vehicle or moving components of vehicle subsystems in an engineering design simulation, and so on. During the pre-processing steps, each of the low LOD object and the high LOD object is stationary. No animation is yet occurring. In an implementation, when executing commands, which are translated from instructions of surface characterizer 115, circuit 102 generates a set of adjustment displacements for the low LOD object, which are used to generate a representation of the high LOD object. To generate the set of adjustment displacements, when executing the commands, circuit 102 utilizes both a curved height field and displacement information across the surface of the high LOD object. The set of adjustment displacements indicate surface differences between the high LOD object and the curved height field corresponding to the low LOD object. Further details are provided in the description of FIGS. 3-8.

In an implementation, when executing instructions of a kernel mode driver (KMD), circuitry 118 assigns state information for a command group that includes at least the modified sequence of instructions 113 generated by compiling application 116. Examples of the state information are a process identifier (ID), a name of the application or an ID of the application, a version of the application, a compute/graphics type of work, and so on. When executing instructions of the kernel mode driver, circuitry 118 sends the command group and state information to a ring buffer 112 in the memory devices 140. The processing circuit 102 accesses, via the memory controllers 130, the command group and state information stored in the ring buffer.

The processing circuit 102 schedules the retrieved commands to the compute circuits 104A-104N based on at least the state information. Other examples of scheduling information used to schedule the retrieved commands are age of the commands, priority levels of the commands, an indication of real-time data processing of the commands, and so forth. Besides the kernel mode driver (KMD), the computing system 100 uses other device drivers (drivers) of a driver stack during the compilation and execution of the application 144. The driver stack allows each driver to specialize in a particular type of function and decouples it from having to know about other drivers. Examples of the other drivers are user mode drivers, an input/output (I/O) interface of the operation system 142, and a file system driver.

In some implementations, computing system 100 utilizes a communication fabric (“fabric”), rather than the bus 125, for transferring requests, responses, and messages between the processing circuits 102 and 110, the I/O interfaces 120, the memory controllers 130, the network interface 135, and the display controller 150. When messages include requests for obtaining targeted data, the circuitry of interfaces within the components of computing system 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processing circuits 102 and 110. While memory controllers 130 are shown as being separate from processing circuits 102 and 110, it should be understood that this merely represents one possible implementation. In other implementations, one of memory controllers 130 is embedded within one or more of processing circuits 102 and 110 or it is located on the same semiconductor die as one or more of processing circuits 102 and 110. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, one or more device drivers, and application 144. In some implementations, the application 144 is a highly parallel data application such as a video graphics application, a shader application, or other. Copies of these instructions can be stored in a memory or cache device local to processing circuit 110 and/or processing circuit 112.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 receives and sends network messages across a network.

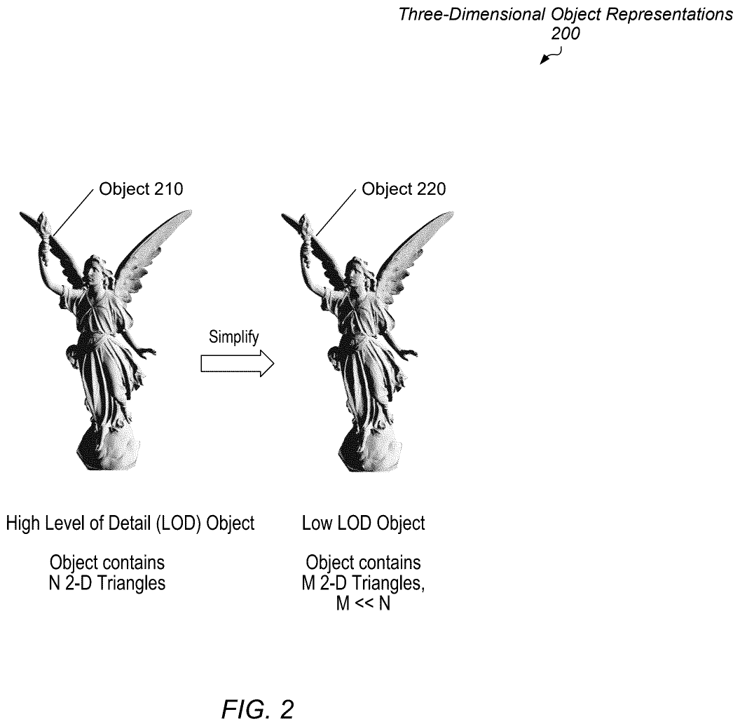

Turning now to FIG. 2, a block diagram is shown of three-dimensional object representations 200 used for performing efficient video processing that preserves clarity of complex surface details. The three-dimensional object representations 200 include object 210 and object 220. Object 210 is a three-dimensional (3-D or 3D) high level of detail (LOD) object that provides a video game character. Object 210 includes N triangles that provide a geometric representation of the video game character. Here, N is a positive, non-zero integer and can be as large as a million in some examples. Although triangles are described here, in other implementations, another geometric shape is used to provide the geometric representation of object 210. The triangles are two-dimensional (2-D or 2D) geometric shapes positioned at different angles or rotations in the 3D space of object 210 and object 220.

In various implementations, object 210 is a 3D object that is to be used in 3D animation provided by a video processing application such as a video game. The user provides the input to select the high LOD object through a button on a graphical user interface (GUI), a text command on a command line, or an instruction of a software program such as a script. Although object 210 is shown as a video game character for a video game application that uses 3D animation, in other implementations, depending on the application and its use, object 210 can be an avatar or a character of an educational or a marketing presentation, a human organ or a group of organs of a medical instructional presentation, a vehicle or moving components of vehicle subsystems in an engineering design simulation, and so on. Therefore, in addition to video game products, real-time video processing occurs for displaying 3D objects in a variety of other fields such as biomedicine, urban planning, education, marketing, architecture, filmmaking, engineering, and so forth. The data files used to represent object 210 can use any one of a variety of file formats. Examples of file formats are the Filmbox (FBX) format, the OBJ format, the STL (stereolithography) format, the GLB (GL Transmission Format Binary) format, and so forth.

The above video processing products offer complex surface details of the 3D objects such as object 210. To reduce the demands on a user's computing device, such as the memory subsystem and the capability of one or more processing circuits, object 220 is generated based on object 210. Object 220 includes M triangles that provide a geometric representation of the video game character. Here, M is a positive, non-zero integer that is less than N. In some implementations, N is in the range of a million triangles, whereas M is in the range of a thousand triangles. When executing the instructions of the video processing application or the instructions of a kernel of a SDK, a processing circuit of the user's computing device automatically generates object 220 after the user's selection of object 210. To generate object 220 from object 210, the processing circuit executes the instructions of one of a variety of methods that compress object 210.

Referring to FIG. 3, a generalized block diagram is shown of geometric shapes 300 of an object used for performing efficient video processing that preserves clarity of complex surface details. The two-dimensional (2-D or 2D) geometric shapes 300 include triangle 310 and triangle 320. Triangle 310 is one of multiple triangles used to represent a 3D low LOD object or a 3D high LOD object. For example, triangle 310 can be used with multiple other triangles to represent object 220 (of FIG. 2). Triangle 310 is one of multiple two-dimensional (2-D or 2D) geometric shapes positioned at different angles or rotations in a 3D space of the low LOD object.

In an implementation, the 3D low LOD object uses x, y, and z (or “X,” “Y,” and “Z”) coordinates of a 3D space, whereas the 2D triangle 310 uses u and v (or “U” and “V”) coordinates of a 2D space such as a UV texture space. When executing the instructions of a video processing application, the hardware of a processing circuit performs the steps of UV mapping, which includes generating a flat 2D representation of a 3D object with volume (or depth) and shape. In an example, the 3D face of object 220 with volume and multiple shapes is generated or projected on a flat 2D space. A pair of u and v coordinates is stored in a vertex of the 3D surface of the low LOD object such as object 220. For example, the u and v coordinates of triangle 310 can be stored in a vertex used in the nose of the character represented by object 220. Vertices grouped together form edges, edges grouped together form faces, faces grouped together form polygons, and polygons grouped together form surfaces (or meshes).

In some cases, the video processing application automatically performs UV mapping using one of a variety of 3D graphics tools. Examples of these 3D graphics tools are Maya, Blender, Cinema 4D, and so on. In other cases, the user also performs manual editing to complete UV mapping, since projection of the 3D object onto the 2D representation can occur in multiple different ways such as using spherical maps, cylinder maps, planar maps, and so on. In yet other cases, multiple types of projection methods are used due to the complex shape of the 3D object. For example, the torch, wings, and clothing of the character represented by object 220 has multiple complex shapes.

To generate a representation of high LOD object 210 from low LOD object 220, the hardware of a processing circuit, when executing instructions of a video processing application, subdivides triangle 310. Triangle 320 represents triangle 310 after dividing or segmenting triangle 310 to include multiple smaller sub-triangles such as sub-triangle 330. Triangle 320 represents a portion of multiple portions of a surface of an object, and sub-triangle 330 represents a sub-portion of the surface. In the illustrated implementation, triangle 320 includes 16 sub-triangles. However, any number of sub-triangles can be used, and the number can be based on design requirements. After subdividing triangle 310 to generate triangle 320, when executing the instructions of the video processing application, the processing circuit performs other steps to facilitate adding texture to triangle 320. These steps include generating vertex normals. Further details are provided in the following description of two-dimensional geometric shapes 400.

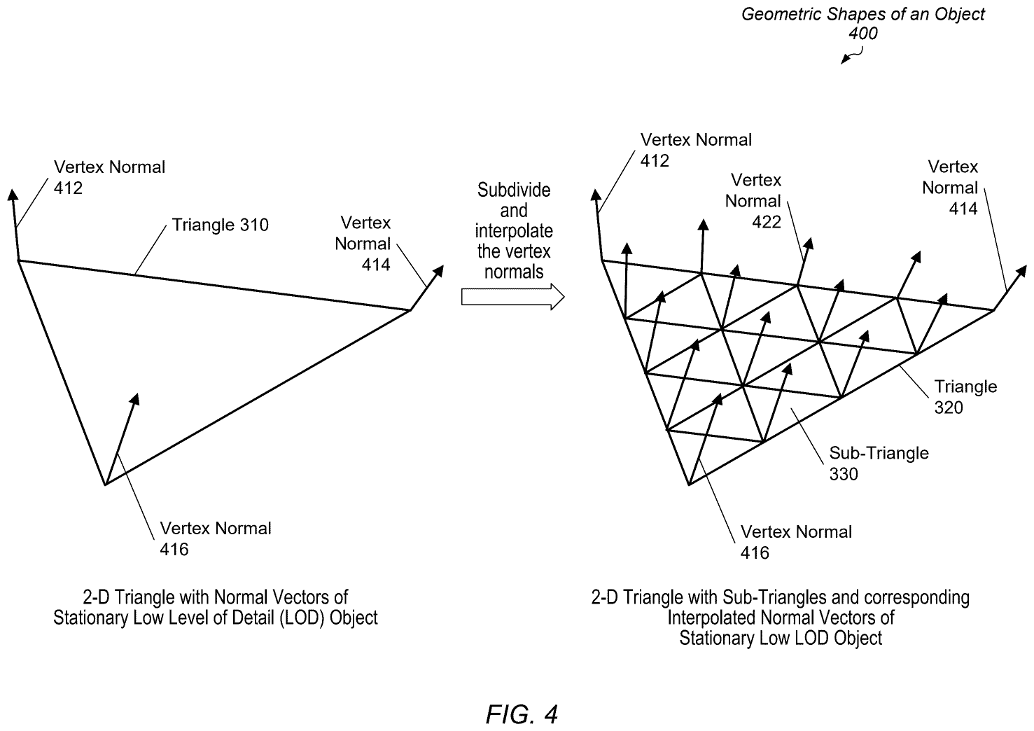

Turning now to FIG. 4, a block diagram is shown of geometric shapes 400 of an object used for performing efficient video processing that preserves clarity of complex surface details. Components described earlier are numbered identically. The two-dimensional (2-D or 2D) geometric shapes 400 include triangle 310 and triangle 320. After UV mapping, texture can be applied to triangle 310 and many other triangles used to characterize and create a 3D object such as object 220. A texture map for triangle 310 includes data that specifies color, surface texture (rough, smooth, dented, reflective), and small repeating details (multiple scratches, multiple ridges). Texture mapping includes the steps of applying these traits to the surface of triangle 310 and many other 2D triangles, which are rotated at different angles in the 3D space of the low LOD object such as object 220. It is noted that in some implementations, during texture mapping, the video processing application can use other types of coordinates to specify locations. One example is barycentric coordinates used to specify the location of a point with respect to a line, a triangle, or other geometric shape.

Triangle 310 includes vertex normals 412, 414 and 416 with one vertex normal at each of its three vertices. The video processing application includes instructions that generate vector normals (i.e., normal vectors or normals) triangles and other geometric shapes. As described earlier, the video processing application can automatically perform UV mapping using one of a variety of 3D graphics tools such as Maya, Blender, Cinema 4D, and so on. These 3D graphics tools can also be used to generate the vertex normals 412, 414 and 416 of triangle 310. Vertex normal 412, 414 and 416 are values that represent lines pointing out of the vertices of triangle 310 oriented perpendicular to the smooth underlying surface from which triangle 310 was generated.

During later video graphics processing steps, the video graphics application compares these values of vertex normals 412, 414 and 416 to the direction of incoming light rays. For example, a graphics rendering stage generates light reflection texture at the location of the particular vertices. If the lines represented by vertex normals 412, 414 and 416 directly face the incoming light rays, then the corresponding surface is brightly lit in the corresponding 3D object such as object 220. If the lines represented by vertex normals 412, 414 and 416 face away from the incoming light rays, then the corresponding surface is not lit in the corresponding 3D object such as object 220. Lighting effects of a corresponding 3D object, such as object 220 (of FIG. 2), are achieved and altered by changing the values of the vertex normals 412, 414 and 416.

Triangle 320 includes multiple sub-triangles such as sub-triangle 330. Additionally, triangle 320 includes a vertex normal at each vertex of the multiple sub-triangles. Vertex normal 422 is one of these vertex normals. To generate these vertex normals, such as vertex normal 422, the video processing application performs linear interpolation of the vertex normals 412, 414 and 416. The video processing application can export the presently used values of the vertex normals 412, 414 and 416 and the presently used vertex normals of the sub-triangles to a geometry file along with the locations (e.g., u and v coordinates) of the corresponding vertices of triangle 320, the locations (e.g., u and v coordinates) of the corresponding vertices of the sub-triangles, an identifier of triangle 320, and so forth.

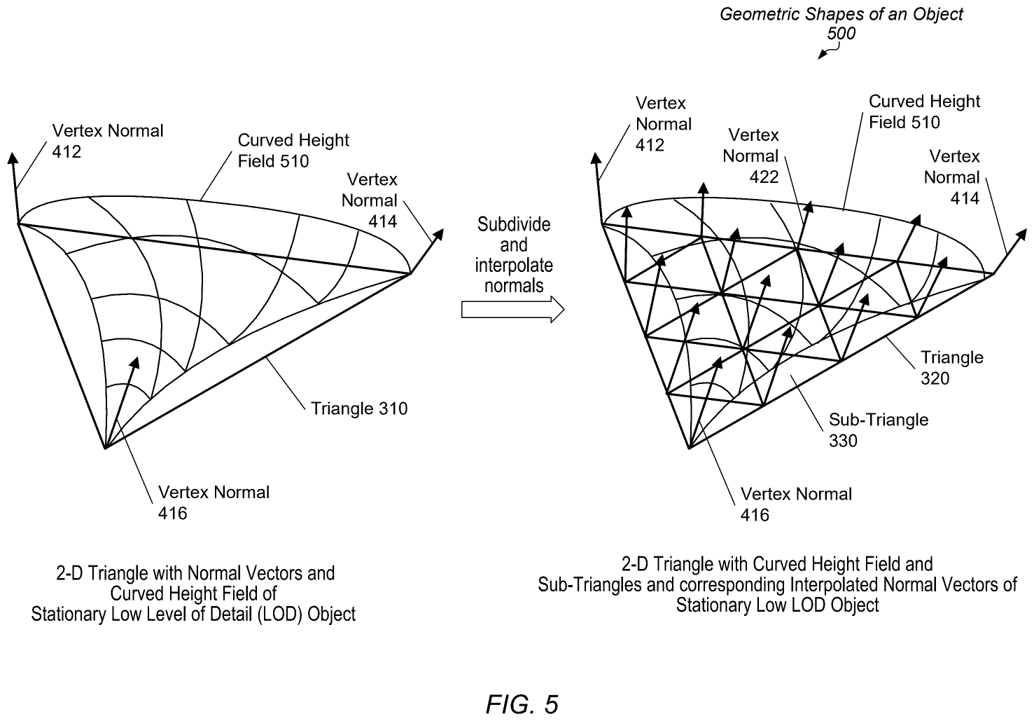

Referring to FIG. 5, a generalized diagram is shown of geometric shapes 500 of an object used for performing efficient video processing that preserves clarity of complex surface details. Components described earlier are numbered identically. The two-dimensional (2-D or 2D) geometric shapes 500 include triangle 310 and triangle 320. Triangle 310 includes vertex normals 412, 414 and 416 with one vertex normal at each of its three vertices. As shown, triangle 310 also includes curved height field 510. Curved height field 510 is a parametric, continuous three-dimensional surface that approximates the surface of a region of a high LOD object, such as object 210, that includes triangle 310 where no mathematical representation of the surface of the region is provided. In an implementation, curved height field 510 is a triangular Bézier surface.

Curved height field 510 is generated by a processing circuit executing instructions of a particular method that uses a formula or a function that generates multiple one-dimensional height values based on locations of the vertices of triangle 310. In various implementations, the locations of the vertices of triangle 310 are indicated by 2D coordinates such as u and v coordinates. As described earlier, triangle 320 is triangle 310 after being subdivided with sub-triangles such as sub-triangle 330. Additionally, in some implementations, the processing circuit executing instructions of the method also generates multiple one-dimensional height values based on locations of the vertices of sub-triangles such as sub-triangle 330. Therefore, the processing circuit generates a portion of curved height field 510 shared by two edges of two neighboring triangles such that the shared edges of the two neighboring triangles provide the same multiple one-dimensional height values. The two neighboring triangles can include triangle 310 and a neighboring triangle (not shown). The two neighboring triangles can also include sub-triangle 330 and a neighboring sub-triangle.

After generating the multiple one-dimensional height values using the locations of vertices of triangle 320 and locations of vertices of sub-triangles, such as sub-triangle 330, when executing instructions of the formula, the processing circuit multiplies each of the multiple one-dimensional height values with a corresponding vertex normal. The product of the one-dimensional height value at a particular location, such as a vertex of triangle 320 or sub-triangle 330, and the corresponding vertex normal at the particular location provides a displacement. The displacement runs along the vertex normal and provides an offset between the particular location (particular vertex) and curved height field 510. Further details of this step are provided in the upcoming description of geometric shapes 600.

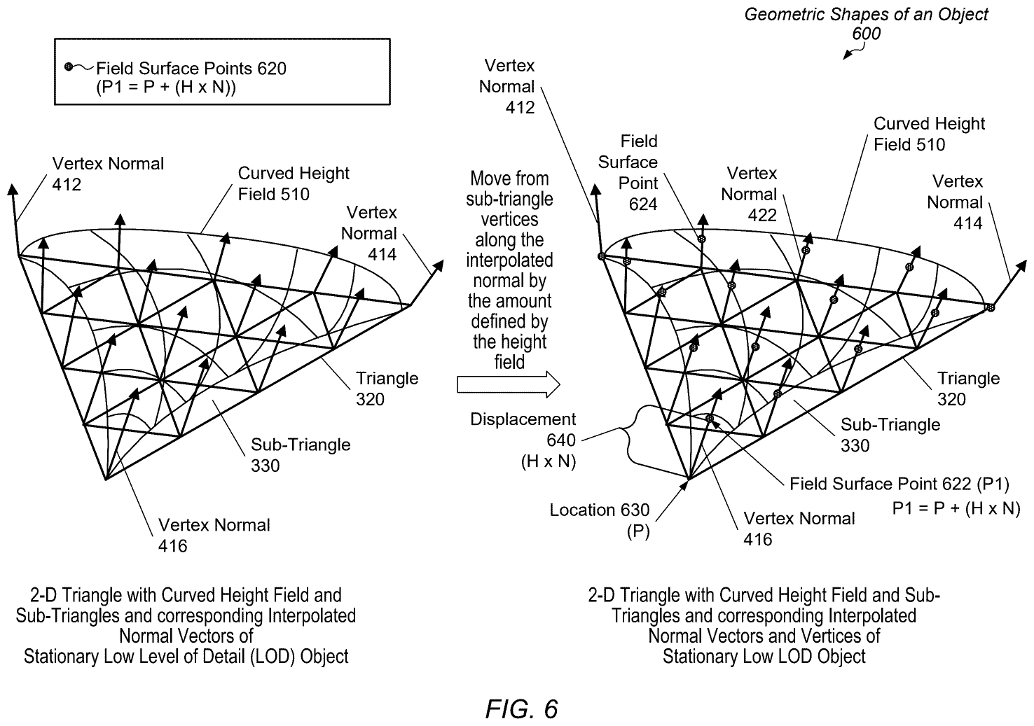

Turning now to FIG. 6, a generalized diagram of geometric shapes 600 of an object used for performing efficient video processing that preserves clarity of complex surface details. Components described earlier are numbered identically. The two-dimensional (2-D or 2D) geometric shapes 600 include triangle 310 and triangle 320. Triangle 310 includes vertex normals 412, 414 and 416 with one vertex normal at each of its three vertices. As shown, curved height field 510 can be generated from the locations of the vertices and corresponding vertex normals 412, 414 and 416 of each of triangle 310 and triangle 320. Additionally, curved height field 510 can be generated from the locations of the vertices and corresponding vertex normals of each of the sub-triangles such as sub-triangle 330.

In some implementations, circuitry of a processing circuit selects a position “P”, such as location 630, on triangle 320 using a pair of 2D coordinates. In some implementations, the circuitry uses a pair of coordinates of a UV map to locate the position P (location 630). The circuitry generates a one-dimensional height value “H” using the pair of coordinates and the formula or function corresponding to curved height field 510. Following, the processing circuit generates the product of the one-dimensional height value H at position P (location 630) and the corresponding vertex normal N (vertex normal 416) at location 630, and this product is (H×N). The product provides the displacement 640. For example, field surface point 620, which intersects with curved height field 510, is located a height value H from position P (location 630) of triangle 320 along the corresponding vertex normal 416. As used herein, a “displacement” along a vertex normal can also be referred to as an “offset” along the vertex normal. The circuitry generates, at a location pointed to by the pair of coordinates, an offset P1 based on P, H and N where N is the vertex normal. In an implementation, the circuitry of the processing circuit executes instructions of a video processing circuit that uses the formula P1=P+(H×N). Field surface point 622 is located at a displacement (or height or offset) from the 2D flat surface of triangle 320 that is equal to P1. A corresponding field surface point of the field surface points 620 exists for each of the vertex normals of triangle 320 and for of the vertex normals of the sub-triangles.

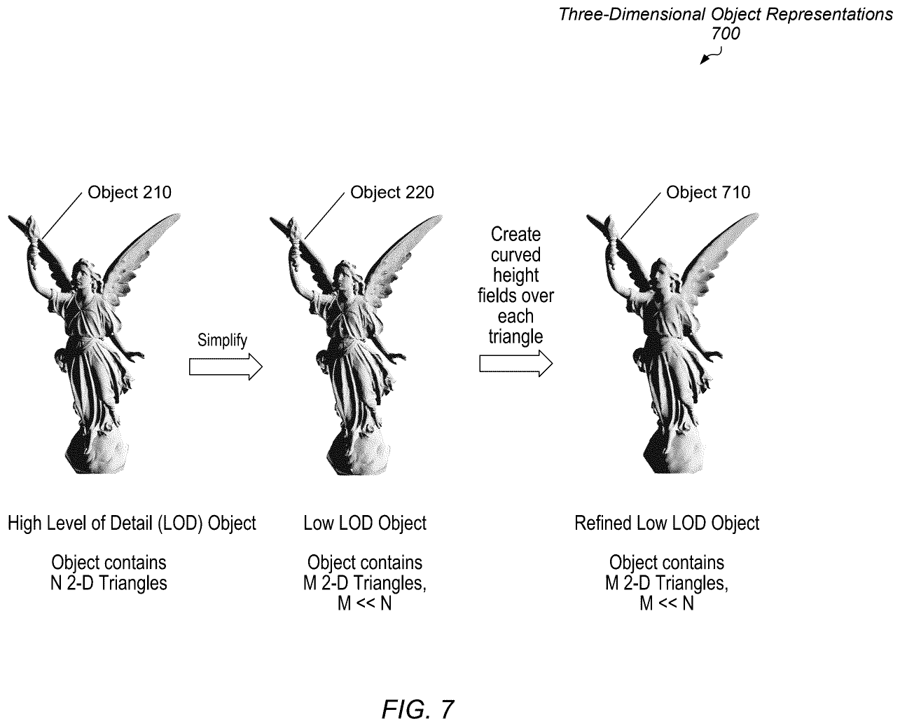

Turning now to FIG. 7, a block diagram is shown of three-dimensional object representations 700 used for performing efficient video processing that preserves clarity of complex surface details. Components described earlier are numbered identically. The three-dimensional object representations 700 include object 210, object 220, and object 710. Object 710 is a refined low LOD object based on each of object 210 and object 220. For example, in an implementation, object 710 is generated using curved height field 510 and the formula P1=P+(H×N) that defines field surface points.

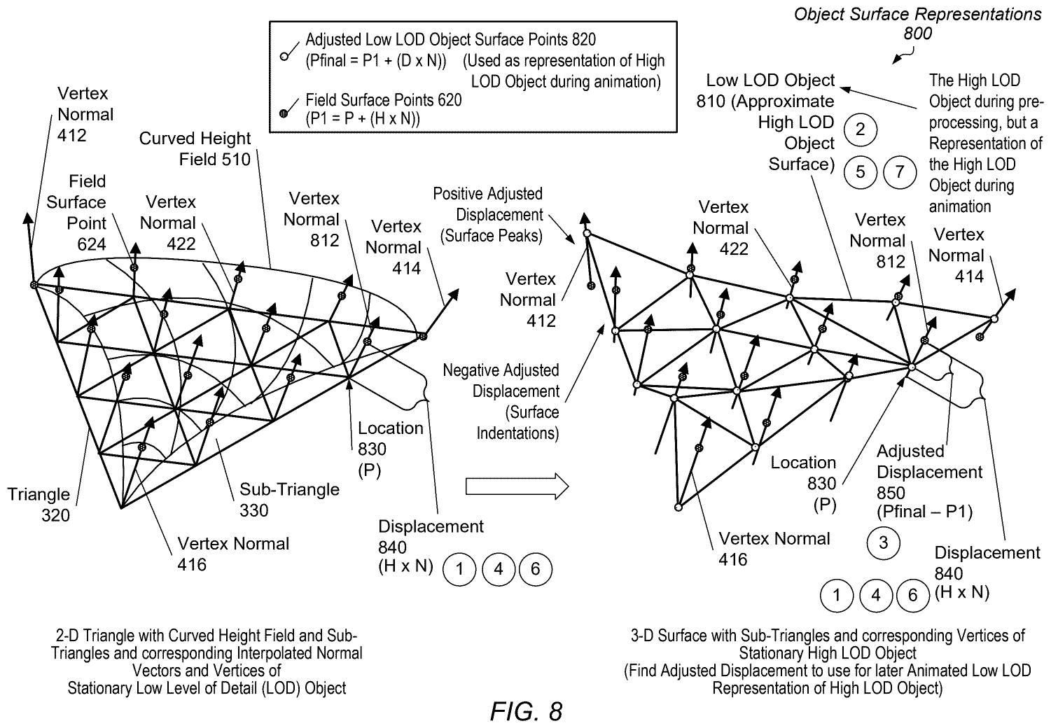

Referring to FIG. 8, a block diagram is shown of object surface representations 800 used for performing efficient video processing that preserves clarity of complex surface details. Components described earlier are numbered identically. The 2D triangle 320 includes vertex normals 412, 414 and 416 and vertex normals at vertices of sub-triangles such as vertex normal 422 and vertex normal 812. Triangle 320 also includes curved height field 510. A timing sequence is shown with seven sequences, each with a corresponding circled sequence number. At sequence 1, as described earlier, when executing the instructions of a video processing application and a surface characterizer tool, the circuitry of a processing circuit generates, at a location pointed to by the pair of coordinates, an offset (or displacement) P1 based on P (2D location of triangle vertex), H (one-dimensional height value provided by curved height field 510), and N (the vertex normal at location P). In an implementation, the circuitry of the processing circuit executes instructions of a video processing tool that uses the formula P1=P+ (H×N). The circuitry generates a one-dimensional height value “H” using the pair of coordinates for location 830 and the formula or function corresponding to curved height field 510. Following, the processing circuit generates the product of the one-dimensional height value H at position P (location 830) and the corresponding vertex normal N (vertex normal 812) at location 830, and this product is (H×N). The product provides displacement 840. For example, a corresponding one of the field surface points 620 is located a height value H from position P (location 830) of triangle 320 along the corresponding vertex normal 812.

During sequence 2, the LOD object surface 810 is the surface of the high LOD object such as object 210 (of FIG. 2). During subsequent sequences, such as sequences 5 and 7, the LOD object surface 810 is a surface of a low LOD object that provides a representation of the original (and stationary) high LOD object such as object 210 (of FIG. 2). During sequence 2, the offsets along the vertex normal of triangle 320 and the sub-triangles are based on location information stored for the original (and stationary) high LOD object such as object 210. These offsets define the locations of corresponding surface points of the stationary high LOD object surface points 820 on the stationary high LOD object surface 810 (or surface 810). The field surface points 620 are also shown along the vertex normals. During sequence 2, the processing circuit retrieves surface points of a high LOD object, such as object 210 (of FIG. 2), and generates or retrieves the corresponding displacements along the vertex normal, such as vertex normal 812.

At sequence 3, the processing circuit compares the displacements of the high LOD object, such as object 210 (of FIGS. 2 and 7) with the displacements, such as displacement 840, of the field surface points 620 of a low LOD object such as object 710 (of FIG. 7).

Along the vertex normal 812, adjustment displacement 850 is the difference between one of the surface points 820 of the high LOD object, such as object 210 (of FIG. 2), and a corresponding one of the field surface points 620 of the low LOD object such as object 710 (of FIG. 7). In an implementation, the processing circuit performs a raytracing operation from the corresponding one of the field surface points 620 along the vertex normal 812 to the one of the corresponding surface points of the stationary high LOD object surface points 820. The result is the adjustment displacement 850. In other implementations, the processing circuit uses another operation to generate the adjustment displacement 850 by comparing one of the field surface points 620 along the vertex normal 812 to the one of the corresponding surface points of the stationary high LOD object surface points 820. Only during sequence 3 is the object surface 810 associated with the high LOD object such as object 210 (of FIG. 2). Additionally, the generation of the adjustment displacements, such as adjustment displacement 850, occurs only once, which is done during sequence 3.

The processing circuit stores this adjustment displacement 850 along with other adjustment displacements in a predetermined data storage location. In some implementations, each adjustment displacement is stored as a pair of values along with its a unique identifier of a corresponding triangle or a sub-triangle are stored as pairs. The adjustment displacements, such as adjustment displacement 850, can be positive or negative. Each of the adjustment displacements, such as adjustment displacement 850, includes both a sign and a magnitude. Examples of positive and negative adjustment displacements are illustrated for surface 810.

The adjustment displacements are relatively small, since the adjustment displacements are measured from the generated field surface points of the updated low LOD object, such as field surface points 620, rather than measured from the corresponding base triangle (base triangle 320) or sub-triangle (sub-triangle 330). Therefore, the magnitudes of the adjustment displacements, such as adjustment displacement 850), are less than the magnitudes of displacements measured from a base triangle (base triangle 320) or sub-triangle (sub-triangle 330). The small magnitudes of the adjustment displacements reduces the data storage capacity used to store the pair of values with each pair including the adjustment displacement and a unique identifier of a corresponding triangle or a sub-triangle. It is noted that after using the curved height field 510 and using the comparisons with the retrieved surface points of the high LOD object, the adjustment displacements, such as adjustment displacement 850, can have negative values. Therefore, object 710 (of FIG. 7) can have valleys and indentations and further visual fidelity than provided by object 220 (of FIGS. 2 and 7), which is the output of the video compression method.

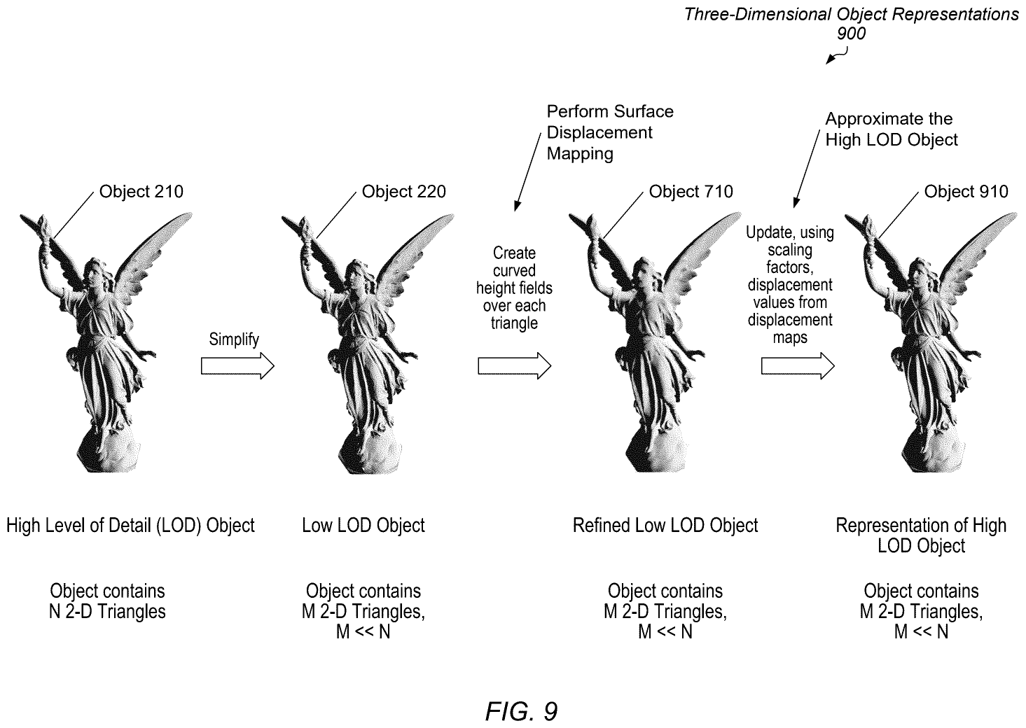

The adjustment displacements are used for later 3D animation. At this time, each of the high LOD object, such as object 210 (of FIGS. 2 and 7), and the low LOD object, such as object 710 (of FIG. 7) used as a representation of the high LOD object is still stationary. The processing circuit generates, using the adjustment displacements, an updated low LOD object that is a representation of the high LOD object. Object 910 (of FIG. 9) is an example of the updated low LOD object. During sequence 3, when executing the instructions of the video application and the surface characterizer, the processing circuit is performing pre-processing steps prior to when 3D animation occurs during execution of the video application.

At sequence 4, 3D animation has begun for the video processing application, and the locations of triangle 320, the sub-triangles, such as sub-triangle 330, and the vertex normal, such as vertex normal 412-416, have changed. In sequence 4, the processing circuit repeats the steps performed for sequence 1. The processing circuit generates an updated curved height field 510 and generates updated field surface points 620 based on the updated curved height field 510 and the updated locations. The steps of sequence 2 are not repeated. No preexisting surface points are retrieved from data storage. Additionally, the steps of sequence 3 are not repeated. Rather, the processing circuit retrieves the values of the adjustment displacements, such as adjustment displacement 850, from data storage and uses them again. At sequence 5, the adjustment displacements are summed with the displacements generated in sequence 4. Taking vertex normal 812 as an example, the retrieved value of adjustment displacement 850 is summed with the displacement 840 generated in sequence 4. Doing so generates the low LOD object surface points 820 used to provide the low LOD object surface 810 as a representation of the high LOD object such as object 210 (of FIG. 2).

Each of the adjustment displacements is represented by “D.” As shown, the position Pfinal of one of the corresponding surface points of the low LOD object surface points 820 is based on the formula Pfinal=P1+(D×N). At sequence 6, further execution of the video application occurs, which includes 3D animation. The processing circuit again updates the curved height field 510 based on the new positions of moving portions of the updated low LOD object. The processing circuit retrieves the stored adjustment displacements from memory. Based on the updated curved height field, the processing circuit generates modified displacements across the surface of the updated low LOD object 810 similar to steps performed in sequence 4. In sequence 7, the processing circuit performs steps similar to steps of sequence 5. For example, the adjustment displacements are summed with the displacements generated in sequence 6. Taking vertex normal 812 as an example, the retrieved value of adjustment displacement 850 is summed with the displacement 840 generated in sequence 6. Doing so generates the low LOD object surface points 820 used to provide the low LOD object surface 810 as a representation of the high LOD object such as object 210 (of FIG. 2). By doing so, the processing circuit efficiently performs video processing that preserves clarity of complex surface details. When animation of the updated low LOD object 810 occurs during execution of the video application, the processing circuit updates the locations (P) of vertices of base triangles and sub-triangles, updates vertex normals (N) of the base triangles and the sub-triangles and updates the one-dimensional height values (H) based on updated locations (P) of vertices and the curved height field. Using these updated values, the processing circuit uses the formula P1=P+(H×N) to update the field surface points 620 along the vertex normal.

It is noted that it is possible that one or more adjustment displacements are negative values. Examples of positive and negative adjustment displacements are illustrated for surface 810. In some implementations, when one of the LOD object surface points 820 on a vertex normal is located farther away from the base triangle than a corresponding one of the field surface points 620, the adjustment displacement is considered positive. In contrast, when one of the field surface points 620 is located farther away from the base triangle than a corresponding one of the LOD object surface points 820 on a vertex normal, the adjustment displacement is considered negative. Positive adjustment displacements indicate peaks or bulges on the surface of the high LOD object 210 compared to the low LOD object 220 (of FIG. 2). Negative adjustment displacements indicate valleys or indentations on the surface of the high LOD object 210 compared to the low LOD object 220 (of FIG. 2). The adjustment displacements are also relatively small, since the adjustment displacements are measured from the generated field surface points of the updated low LOD object, rather than measured from the corresponding base triangle or sub-triangle. Therefore, the adjustment displacements, such as adjustment displacement 850, are less than displacements measured from a base triangle (base triangle 320) or sub-triangle (sub-triangle 330). The small sizes of the adjustment displacements reduces the data storage capacity used to store the pair of values with each pair including the adjustment displacement and a unique identifier of a corresponding triangle or a sub-triangle. The steps described for FIGS. 3-8 allow the level of detail to be available for another low LOD object based on the high LOD object 210, the low LOD object 220, and the curved height field 510.

Referring to FIG. 9, a block diagram is shown of three-dimensional object representations 900 used for performing efficient video processing that preserves clarity of complex surface details. Components described earlier are numbered identically. The three-dimensional object representations 900 include object 210, object 220, object 710, and object 910. Object 910 is a representation of a high LOD object such as object 210. During the pre-processing steps prior to 3D animation, when executing the instructions of the surface characterizer, the processing circuit retrieves the final surface points of the stationary high LOD object (object 210) from data storage and generates adjustment displacements such as adjustment displacements 850 of FIG. 8. To do so, the processing circuit uses the formula P1=P+(H×N) and performs comparisons between the surface points of the high LOD object, such as object 210 (of FIG. 2), and multiple field surface points, such as filed surface points 620, along the corresponding vector normal.

At a later time, 3D animation occurs such as the character represented by object 910 raises arms, rotates, jumps, or performs another animated action. Responsive to an indication from the video application specifying the animated movement of the character represented by object 910, when executing the instructions of the surface characterizer, the processing circuit updates the values P, H and N, and retrieves the adjustment displacements (D) from memory. Following, the processing circuit uses the formula for P1 and then Pfinal to generate the updated final surface point (Pfinal) of the animated version of the character represented by object 910.

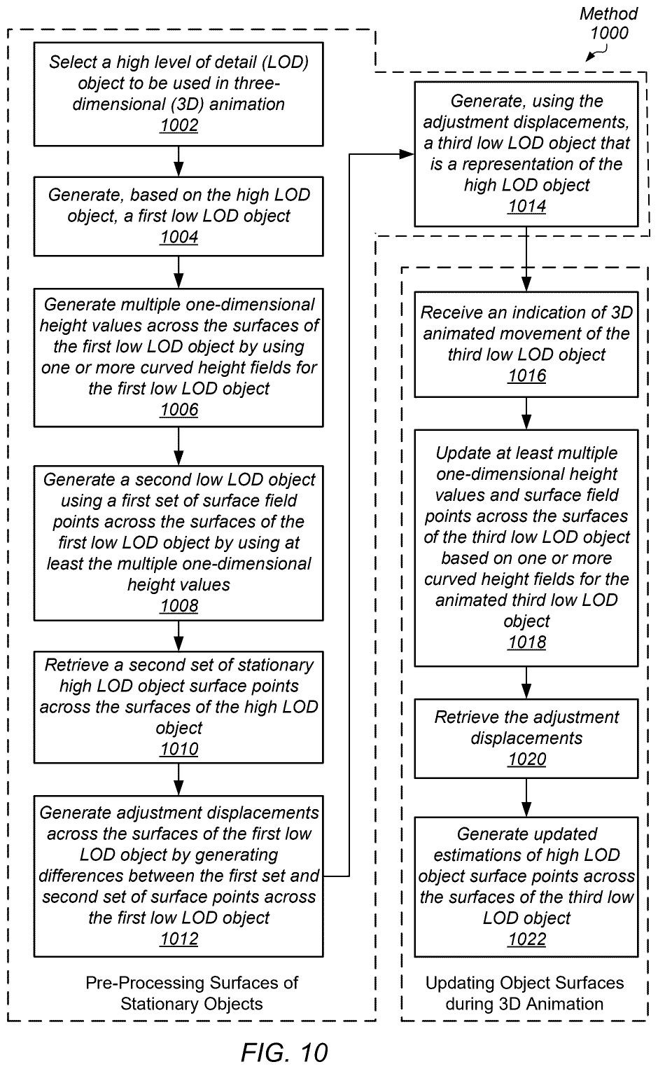

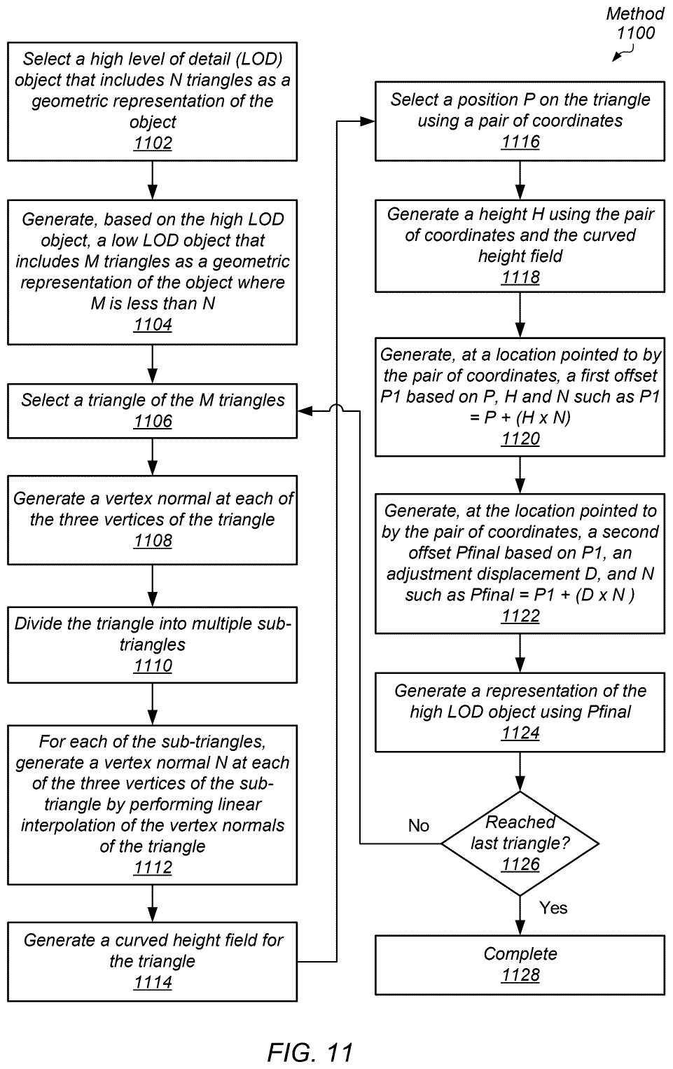

Referring to FIG. 10, a generalized diagram is shown of a method 1000 for performing efficient video processing that preserves clarity of complex surface details. For purposes of discussion, the steps in this implementation (as well as FIG. 11) are shown in sequential order. However, in other implementations some steps occur in a different order than shown, some steps are performed concurrently, some steps are combined with other steps, and some steps are absent.

A user executes a video processing application that uses three-dimensional animation on the user's computing device. Examples of the user's computing device are a desktop computer, a laptop computer, a smartphone, a tablet computer, and so forth. The video processing application can be from one of multiple fields such as entertainment, medicine, business marketing, education, engineering, and so forth. The user provides input to select a high level of detail (LOD) object to be used in three-dimensional (3D) animation (block 1002). In an implementation, the high LOD object is object 210 (of FIG. 2). Circuitry of a processing circuit of the user's computing device executes the instructions of the video processing application and a tool such as a surface characterizer. The surface characterizer executes steps of a pre-processing operation prior to any 3D animation is performed. The circuitry generates a first low LOD object based on the high LOD object (block 1004). In various implementations, the circuitry executes instructions of a video compression method to generate the first low LOD object. In an implementation, the first low LOD object is object 220 (of FIG. 2).

In some implementations, each of the high LOD object and the first low LOD object is a video game character for a video game application that uses 3D animation. In other implementations, depending on the application and its use, each of the high LOD object and the first low LOD object can be an avatar or a character of an educational or a marketing presentation, a human organ, or a group of organs of a medical instructional presentation, a vehicle or moving components of vehicle subsystems in an engineering design simulation, and so on. As shown, blocks 1002-1014 are placed in a dashed line box to group blocks directed toward pre-processing operation targeting stationary objects prior to any 3D animation is performed. Blocks 1016-1022 are placed in a dashed line box to group blocks directed toward a dynamic updating operation of surfaces of an object when 3D animation is performed.

Regarding the pre-processing operation, the circuitry generates multiple one-dimensional height values across the surfaces of the first low LOD object by using one or more curved height fields for the first low LOD object (block 1006). In various implementations, the locations of vertices of geometric shapes, such as triangles and sub-triangles, of the first low LOD object are indicated by 2D coordinates such as u and v coordinates. The circuitry generates a one-dimensional height value “H” using the pair of coordinates and the formula or function corresponding to the curved height field. The circuitry generates a second low LOD object using a first set of surface field points across the surfaces of the first low LOD object by using at least the multiple one-dimensional height values (block 1008). In an implementation, the second low LOD object is object 710 (of FIG. 7). In an implementation, the circuitry generates the product of the one-dimensional height value H at position P (using u, v coordinates) and the corresponding vertex normal N at the location. This product is (H×N). The product (H×N) provides a displacement.

The circuitry retrieves a second set of stationary high LOD object surface points across the surfaces of the high LOD object (block 1010). The circuitry generates adjustment displacements across the surfaces of the first low LOD object by generating differences between the first set and second set of surface points across the first low LOD object (block 1012). The adjustment displacements can be positive or negative. Examples of positive and negative adjustment displacements are illustrated for surface 810 (of FIG. 8). The adjustment displacements are relatively small, since the adjustment displacements are measured from the generated field surface points of the updated low LOD object, rather than measured from the corresponding base triangle or sub-triangle. The circuitry generates, using the adjustment displacements, a third low LOD object that is a representation of the high LOD object (block 1014). In an implementation, the third low LOD object is object 910 (of FIG. 9). The circuitry stores the adjustment displacements in a predetermined storage location or region of memory. In some implementations, each adjustment displacement, and its corresponding position P (using u, v coordinates) are stored in memory as pairs. The circuitry stores the third low LOD object to be later used as a representation of the high LOD object.

During execution of the video processing application, the circuitry receives an indication of 3D animated movement of the second low LOD object (block 1016). The circuitry updates at least multiple one-dimensional height values and surface field points across the surfaces of the third low LOD object based on one or more curved height fields for the second low LOD object (block 1018). In various implementations, the circuitry performs the steps of blocks 1006 and 1008, but with updated positions of vertices of geometric shapes of the third low LOD object such as triangles and sub-triangles. The circuitry also calculates updated values for the vertex normals at these vertices. In various implementations, the circuitry accesses the updated locations of the vertices by indexing a table or other data storage structure with a unique identifier of a triangle or a sub-triangle. The circuitry retrieves the adjustment displacements (block 1020). These adjustment displacements were generated in previous block 1012.

The circuitry generates updated estimations of high LOD object surface points across the surfaces of the third low LOD object (block 1022). For example, the circuitry uses updated values of the parameters P, H and N. The circuitry also uses the adjustment displacements D to generate updated surface points Pfinal across the surfaces of the third low LOD object. To do so, the circuitry first updates field surface points on a curved height field of the animated third low LOD object. Further details of these steps are provided in the description of geometric shapes 500-600 and object surface representations 800 (of FIGS. 5-6 and 8) in addition the description of the steps performed in method 1100 (of method 1100).

Referring to FIG. 11, a generalized diagram is shown of a method 1100 for performing efficient video processing that preserves clarity of complex surface details. A user executes a video processing application that uses three-dimensional animation. The video processing application can be from one of multiple fields such as entertainment, medicine, engineering, and so forth. The user provides input to select a high level of detail (LOD) object that includes N triangles to provide a geometric representation of the object (block 1102). Here, N is a positive, non-zero integer and can be as large as a million in some examples. Although triangles are described here, in other implementations, another geometric shape can be used to provide the geometric representation. In various implementations, the high LOD object is a 3D object that is to be used in 3D animation provided by the video processing application. The user provides the input to select the high LOD object through a button on a graphical user interface (GUI), a text command on a command line, or an instruction of a software program such as a script. Depending on the application and its use, the high LOD object can be a character of a video game application, an avatar, or a character of an educational or a marketing presentation, a human organ, or a group of organs of a medical instructional presentation, and so on.

The data files used to represent the high LOD object can use any one of a variety of file formats. Examples of file formats are the Filmbox (FBX) format, the OBJ format, the STL (stereolithography) format, the GLB (GL Transmission Format Binary) format, and so forth. In addition to video game products, real-time video processing occurs for displaying 3D objects in a variety of other fields such as biomedicine, urban planning, education, marketing, architecture, filmmaking, engineering, and so forth. These video processing products can offer complex surface details of 3D objects.

Circuitry of a processing circuit generates, based on the high LOD object, a low LOD object that includes M triangles as a geometric representation of the object where M is less than N (block 1104). The value M is a positive, non-zero integer that is less than N. In some implementations, N is in the range of a million triangles, whereas M is in the range of a thousand triangles. When executing the instructions of the video processing application or the instructions of a kernel of a SDK, the processing circuit automatically generates the low LOD object after selection of the high LOD object. To generate the low LOD object from the high LOD object, the processing circuit executes the instructions of one of a variety of methods that compress object 210.

The circuitry selects a triangle of the M triangles (block 1106). The circuitry generates a vertex normal at each of the three vertices of the triangle (block 1108). The circuitry divides the triangle into multiple sub-triangles (block 1110). The circuitry generates a vertex normal at each of the three vertices of the sub-triangle by performing linear interpolation of the vertex normals of the corresponding triangle (block 1112). The circuitry generates a curved height field for the triangle (block 1114).

The circuitry selects a position P on the triangle using a pair of coordinates (block 1116). In some implementations, the circuitry uses a pair of coordinates of a UV map to locate the position P. The circuitry generates a height H using the pair of coordinates and the curved height field (block 1118). The circuitry generates, at a location pointed to by the pair of coordinates, a first offset P1 based on P, H and N (block 1120). In an implementation, the circuitry uses the formula P1=P+H×N. The circuitry retrieves an adjustment displacement D using a unique identifier of a corresponding sub-triangle that has a vertex at position P. The circuitry generates, at the location pointed to by the pair of coordinates, a second offset Pfinal based on P1, an adjustment displacement D, and N (block 1122). In an implementation, the circuitry uses the formula Pfinal=P1+D×N.

The circuitry generates a representation of the high LOD object using Pfinal (block 1124). If the circuitry has not yet reached the last triangle of the first low LOD object (“no” branch of the conditional block 1126), then control flow of method 1100 returns to block 1106 where the circuitry selects a triangle of the M triangles. If the circuitry has reached the last triangle of the low LOD object (“yes” branch of the conditional block 1126), then the circuitry has completed generating the representation of the high LOD object as a low LOD object for animation (block 1128). For example, the circuitry has access to the multiple adjustment displacements to use to generate the representation of the high LOD object as a low LOD object during animation.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
subdivide a portion of a surface of a low level of detail (LOD) object, corresponding to a high LOD object, into a plurality of sub-portions;
generate a displacement comprising a first point at which a normal vector corresponding to a given sub-portion, of the plurality of sub-portions, intersects a curved surface above the given sub-portion;
generate an adjusted displacement along the normal vector based on a difference between the first point and a second point at which the normal vector intersects a surface of the high LOD object; and
store, in memory, the adjustment displacement with a unique identifier of the given sub-portion.

2. The apparatus as recited in claim 1, wherein the circuitry is further configured to store the adjustment displacement as a positive displacement or a negative displacement with a sign and a magnitude based on values of the first point and the second point.

3. The apparatus as recited in claim 2, wherein the circuitry is further configured to store the adjustment displacement as a displacement with a first magnitude less than a second magnitude of a displacement measured from the given sub-portion.

4. The apparatus as recited in claim 2, wherein responsive to an update of a position of the given sub-portion, the circuitry is further configured to:
generate updated values for the curved surface, the normal vector, and the first point; and
maintain the adjustment displacement.

5. The apparatus as recited in claim 4, wherein the circuitry is further configured to generate a third point at which the normal vector intersects a surface of a representation of the high LOD object by summing the first point and the adjustment displacement.

6. The apparatus as recited in claim 1, wherein to generate the curved surface, the circuitry is further configured to generate a curved height field for the given sub-portion.

7. The apparatus as recited in claim 6, wherein to generate the first point, the circuitry is further configured to generate a height value using the curved height field and the normal vector.

8. A method, comprising:
subdividing, by circuitry, a portion of a surface of a low level of detail (LOD) object, corresponding to a high LOD object, into a plurality of sub-portions;
generating a displacement comprising a first point at which a normal vector corresponding to a given sub-portion, of the plurality of sub-portions, intersects a curved surface above the given sub-portion;
generating an adjusted displacement along the normal vector based on a difference between the first point and a second point at which the normal vector intersects a surface of the high LOD object; and
storing, in memory, the adjustment displacement with a unique identifier of the given sub-portion.

9. The method as recited in claim 8, further comprising storing, by the circuitry, the adjustment displacement as a positive displacement or a negative displacement with a sign and a magnitude based on values of the first point and the second point.

10. The method as recited in claim 9, further comprising storing, by the circuitry, the adjustment displacement as a displacement with a first magnitude less than a second magnitude of a displacement measured from the given sub-portion.

11. The method as recited in claim 9, wherein responsive to an update of a position of the given sub-portion, the method further comprises:
generating, by the circuitry, updated values for the curved surface, the normal vector, and the first point; and
maintaining, by the circuitry, the adjustment displacement.

12. The method as recited in claim 11, further comprising generating, by the circuitry, a third point at which the normal vector intersects a surface of a representation of the high LOD object by summing the first point and the adjustment displacement.

13. The method as recited in claim 8, wherein to generate the curved surface, the method further comprises generating, by the circuitry, a curved height field for the given sub-portion.

14. The method as recited in claim 13, wherein to generate the first point, method further comprises generating, by the circuitry, a height value using the curved height field and the normal vector.

15. A non-transitory computer readable medium comprising program instructions executable by circuitry to:
receive a low level of detail (LOD) object corresponding to a high LOD object;
subdivide a portion of a surface of the low LOD object into a plurality of sub-portions;
generate a curved surface for a given sub-portion of the plurality of sub-portions;
generate a normal vector corresponding to the given sub-portion;
generate a first point at which the normal vector interests the curved surface;
generate an adjustment displacement along the normal vector based on a difference between the first point and a second point at which the normal vector intersects a surface of the high LOD object; and
store, in memory, the adjustment displacement with a unique identifier of the given sub-portion.

16. The non-transitory computer readable medium as recited in claim 15, wherein the program instructions are executable by circuitry to store the adjustment displacement as a positive displacement or a negative displacement with a sign and a magnitude based on values of the first point and the second point.

17. The non-transitory computer readable medium as recited in claim 16, wherein the program instructions are executable by circuitry to store the adjustment displacement as a displacement with a first magnitude less than a second magnitude of a displacement measured from the given sub-portion.

18. The non-transitory computer readable medium as recited in claim 16, wherein responsive to an update of a position of the given sub-portion, the program instructions are executable by circuitry to:
generate updated values for the curved surface, the normal vector, and the first point; and
maintain the adjustment displacement.

19. The non-transitory computer readable medium as recited in claim 18, wherein the program instructions are executable by circuitry to generate a third point at which the normal vector intersects a surface of a representation of the high LOD object by summing the first point and the adjustment displacement.

20. The non-transitory computer readable medium as recited in claim 15, wherein to generate the curved surface, the circuitry is further configured to generate a curved height field for the given sub-portion.
